(19) United States
(12) Patent Application Publication
(10) Pub. No.: US 2015/0055775 A1
(43) Pub. Date: Feb. 26, 2015

(54) IMAGE PROCESSING APPARATUS AND OPERATION METHOD THEREOF

(71) Applicant: Electronics and Telecommunications Research Institute, Daejeon (KR)

(72) Inventors: Kang Il CHOI, Daejeon (KR); Bhum Cheol Lee, Daejeon (KR); Seung Woo Lee, Daejeon (KR); Young Ho Park, Daejeon (KR); Jung Hee Lee, Daejeon (KR); Sang Min Lee, Daejeon (KR)

(73) Assignee: Electronics and Telecommunications Research Institute, Daejeon (KR)

(21) Appl. No.: 14/063,777

(22) Filed: Oct. 25, 2013

(30) Foreign Application Priority Data
Aug. 20, 2013 (KR) 10-2013-0098441

(51) Int. Cl. H04L 9/30

(52) U.S. Cl. CPC H04L 9/30
USPC 380/28

(57) ABSTRACT

An exemplary embodiment provides an image processing apparatus, including: a first detector configured to detect a privacy image from a first image when the first image is input; a protection processor configured to scramble the privacy image to a privacy protection image using a scrambling key when the privacy image is detected; and an encryption processor configured to create a second image in which the first image including the privacy protection image is encrypted using an encryption key.

### CROSS-REFERENCE TO RELATED APPLICATIONS

This application claims priority to and the benefit of Korean Patent Application No. 10-2013-0098441 filed in the Korean Intellectual Property Office on Aug. 20, 2013, the entire contents of which are incorporated herein by reference.

### TECHNICAL FIELD

An exemplary embodiment relates to an image processing apparatus and an operation method thereof, and more particularly, to an image processing apparatus that may easily prevent leakage of a privacy image included in an input image and an operation method thereof.

### BACKGROUND ART

In general, to monitor the facility such as a predetermined building or convenience facility, video data storage devices are connected to each other over a closed network such as a camera, a monitor, a video recording device, and the like.

In this case, a user agent is present in a user device to provide video data to the user device. Accordingly, a camera, a server, and the user device control the camera through mutual interface communication.

Also, video data photographed from the camera is recorded in a storage device within the server and is also transferred to a viewer of the user device.

The above system is generally configured as a closed network among the camera, the server, and the user device for controlling the camera and storing the video data.

In the closed network, the user agent operating in the user device obtains state information of the camera by transmitting a command to the camera through the server, and the camera transfers current state information to the user agent through the server.

A camera server provides interface communication between the user agent and the camera. Also, the camera server enables a user to store an image through the user agent or enables the server to execute a command, such as displaying the image on the viewer in lieu of the user.

When the user desires the image to be displayed on the viewer of the user device, the image transferred to the server is transferred to the user device. When the user desires to store the image in the storage device, the image transferred to the server is stored in the storage device within the server.

However, a camera monitoring system connected using the closed network has constraints in extensibility. In addition, when the user is not directly connected to the closed network, it is difficult to provide a function capable of controlling the camera through a general network (for example, the Internet) or at least viewing or storing an image.

### SUMMARY OF THE INVENTION

An exemplary embodiment has been made in an effort to provide an image processing apparatus that may easily prevent leakage of a privacy image included in an input image and an operation method thereof.

An exemplary embodiment provides an image processing apparatus, including: a first detector configured to detect a privacy image from a first image when the first image is input; a protection processor configured to scramble the privacy image to a privacy protection image using a scrambling key when the privacy image is detected; and an encryption processor configured to create a second image in which the first image including the privacy protection image is encrypted using an encryption key.

Another exemplary embodiment also provides an operation method of an image processing apparatus, the method including: detecting a privacy image from a first image when the first image is input; scrambling the privacy image to a privacy protection image using a scrambling key when the privacy image is detected; and creating a second image in which the first image including the privacy protection image is encrypted using an encryption key.

An image processing apparatus and an operation method thereof according to exemplary embodiments may scramble a privacy image to a privacy protection image using a set scrambling key when the privacy image is detected from an input image, and then encrypt and store an image using an encryption key, thereby protecting personal privacy information even though the image is leaked through hacking and the like.

An image processing apparatus and an operation method thereof according to exemplary embodiments may be installed in a storage server configured to store an image created by network cameras connected over a network, to scramble, encrypt, and store the image transmitted from the network cameras, and to descramble and decrypt the image when a request signal for the image is input from a control server configured to control the storage server, and to deliver the decrypted image to the control server, thereby preventing leakage of personal privacy information about the image.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a control block diagram illustrating a control configuration of an image processing apparatus according to an exemplary embodiment.

FIG. 2 is a flowchart illustrating an operation method of an image processing apparatus when an image is input to the image processing apparatus according to an exemplary embodiment.

FIG. 3 is a flowchart illustrating an operation method of an image processing apparatus when an image is output from the image processing apparatus according to an exemplary embodiment.

FIG. 4 is a system block diagram briefly illustrating a network camera system including the image processing apparatus of FIG. 1.

It should be understood that the appended drawings are not necessarily to scale, presenting a somewhat simplified representation of various features illustrative of the basic principles of the invention. The specific design features of the invention as disclosed herein, including, for example, specific dimensions, orientations, locations, and shapes will be determined in part by the particular intended application and use environment.

In the figures, reference numbers refer to the same or equivalent parts of the invention throughout the several figures of the drawing.

### DETAILED DESCRIPTION

The following description simply exemplifies a principle of the invention. Accordingly, although not clearly described or illustrated in the present specification, those skilled in the art may configure the principle of the invention and may invent a variety of apparatuses included in the concept and scope of the invention. In addition, all of the conditional terminologies and exemplary embodiments enumerated in the present specification are clearly intended only for the purpose of understanding the concept of the invention, in principle. Accordingly, the invention should not be understood to be limited to the exemplary embodiments and states particularly enumerated as above.

All of the detailed descriptions in which a predetermined exemplary embodiment in addition to the principle of the invention, perspectives, and exemplary embodiments are described should be understood to include structural and functional equivalents of the above matters. Further, the equivalents should be understood to include equivalents currently known and also include equivalents to be developed in the future, that is, all of the devices invented to perform the same function regardless of a type of structure.

Accordingly, for example, a block diagram of the present specification should be understood to indicate an exemplary conceptual perspective of embodying the principle of the invention. Similarly, all of the flowcharts, state conversion diagrams, pseudo codes, and the like, should be understood to indicate a variety of processes that can be expressed by a computer in a computer-readable medium, and that are implemented by the computer or a processor regardless of whether the computer or the processor is clearly illustrated.

Functions of various devices illustrated in the drawings that include the processor or a functional block indicated as a concept similar thereto may be provided by use of exclusive hardware and hardware having a capability of executing software in association with appropriate software. When such functions are provided by the processor, the functions may be provided by a single exclusive processor, a single shared processor, or a plurality of individual processors, and a portion thereof may be shared.

Clear use of the processor, control, or a terminology proposed as a concept similar thereto should not be interpreted by exclusively citing hardware having the capability of executing software, and should be understood to implicitly include ROM, RAM, and a nonvolatile memory for storing digital signal processor (DSP) hardware and software without limitation. Known and commonly-used other hardware may also be included.

In the claims of the present specification, a constituent element expressed as a means to perform a function disclosed in the detailed description is intended to include, for example, a combination of circuit devices configured to perform the function or all of the methods of performing the function that includes every type of software including firmware/micro code, and the like. The constituent element is combined with an appropriate circuit for executing the above software in order to perform the function. The invention defined by the claims is combined with functions provided by variously enumerated means and combined with a scheme required by the claims. Accordingly, any means capable of providing the function should be understood to be equivalent to as verified from the present specification.

The aforementioned objects, features, and advantages will become further obvious through the following detailed description which is associated with the accompanying drawings and accordingly, those skilled in the art may easily implement the technical spirit of the invention. When it is determined that the detailed description related to a related known function or configuration may make the purpose of the invention unnecessarily ambiguous in describing the invention, the detailed description will be omitted herein.

Hereinafter, exemplary embodiments of the invention will be described in detail with reference to the accompanying drawings.

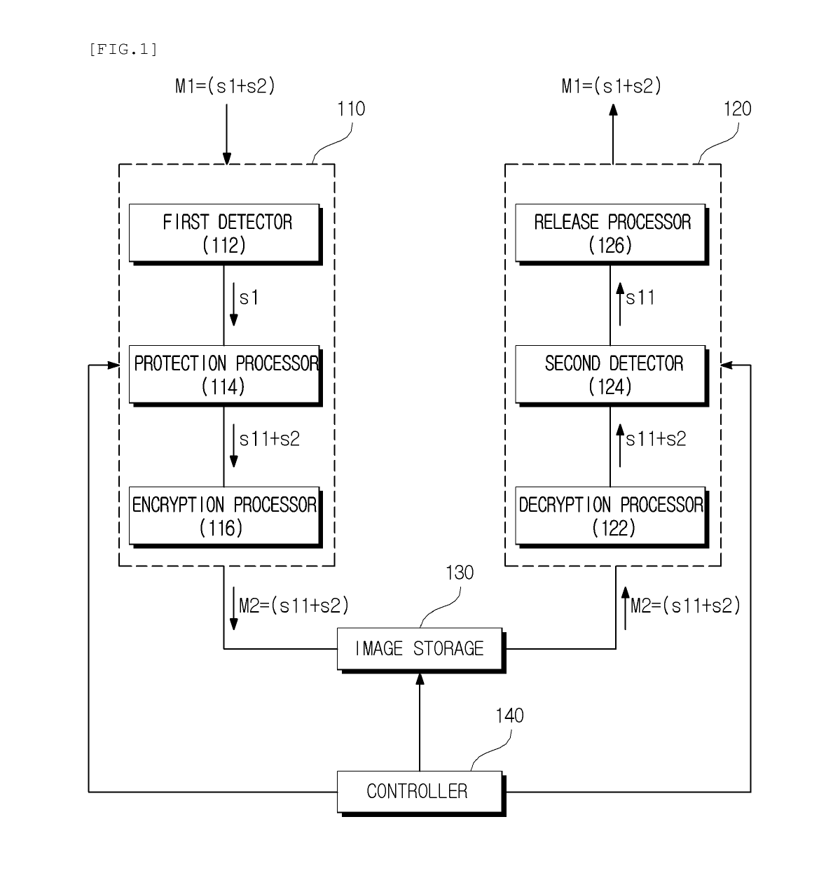

FIG. 1 is a control block diagram illustrating a control configuration of an image processing apparatus according to an exemplary embodiment.

Referring to FIG. 1, the image processing apparatus may include a privacy protection processor 110 configured to create a second image M2 by applying a privacy protection algorithm to a first image M1 when the first image M1 is input, a privacy release processor 120 configured to create the first image M1 by applying a privacy release algorithm to the second image M2 in response to a request for the first image M1, an image storage 130 configured to store the second image M2 created by the privacy protection processor 110 and provide the second image M2 to the privacy release processor 120, and a controller 140 configured to control the privacy protection processor 110, the privacy release processor 120, and the image storage 130.

In an exemplary embodiment, the image processing apparatus may be included in a device capable of photographing an image, for example, an imaging device such as a network camera, a mobile communication terminal, and a closed-circuit television (CCTV), or may be stored in a storage server, for example, a network server and a cloud configured to store an image photographed by the imaging device, but an exemplary embodiment is not limited thereto.

The image processing apparatus of FIG. 1 is described to be separately configured, but may be included and thereby configured in another device as described above.

An exemplary embodiment describes that the first image M1 includes a privacy image s1 including user information, for example, at least one of facial information, license plate information, and privacy information capable of (recognizing a user, and a general image s2 excluding the privacy image s1, but the privacy image s1 may not be included and an exemplary embodiment is not limited thereto.

Initially, the privacy protection processor 110 may include a first detector 112, a protection processor 114, and an encryption processor 116.

The first detector 112 may detect the privacy image s1 from the first image M1.

The first detector 112 may detect the privacy image s1 based on at least one of edge information of the first image M1, shape information, color analysis information, and learning information about a previous privacy image.

That is, the first detector 112 may obtain the edge information by analyzing the first image M1, may detect a boundary between a face and a portion excluding the face using the edge information, and may determine whether the face is present within the first image M1 by comparing a result of analyzing the first image M1 and shape information about a facial shape and the like.

Also, the first detector 112 may compare the color analysis information with unique color distribution information of the face and thus, may more accurately detect the face. Additionally, the first detector 112 may detect a facial area using learning information about the previous privacy image, including an Adaboost learning scheme and the like, but an exemplary embodiment is not limited thereto.

The protection processor 114 may perform masking by scrambling the privacy image s1 detected by the first detector 112 to a privacy protection image s11 using a set scrambling key.

That is, the protection processor 114 may scramble the privacy protection image s11 to be expressed using a predetermined color and a predetermined figure.

Next, the encryption processor 116 may create a second image M2 in which the privacy protection image s11 input from the protection processor 114 and the general image s2 are encrypted using an encryption key.

That is, the encryption processor 116 may increase security about the privacy protection image s11 by encrypting the privacy protection image s11 and the general image s2.

The encryption processor 116 transfers the created second image M2 to the image storage 130.

The image storage unit 130 may assign a unique number capable of recognizing the second image M2 input from the encryption processor 116 and thereby store the second image M2. A method of storing the second image M2 is not limited.

The image storage 130 may transfer the second image M2 to the privacy release processor 120 in response to a control command of the controller 140.

The privacy release processor 120 may operate relatively inversely to the privacy protection processor 110.

That is, the privacy release processor 120 may include a decryption processor 122, a second detector 124, and a release processor 126.

The decryption processor 122 may decrypt the privacy protection image s11 and the general image s2 from the second image M2 using a decryption key when the second image M2 is input from the image storage 130.

Here, the decryption key may be identical to the encryption key, or may be another key capable of performing decryption and corresponding to the encryption key, but an exemplary embodiment is not limited thereto.

The second detector 124 may detect the privacy protection image s11 from the privacy protection image s11 and the general image s2 decrypted by the decryption processor 122.

That is, the second detector 124 may detect, from the privacy protection image s11 and the general image s2, the privacy protection image s11 that is expressed using at least one of the predetermined color and the predetermined figure.

The second detector 124 may detect the privacy protection image s11 based on at least one of edge information of the first image M1 including the privacy protection image s11 and the general image s2, shape information, color analysis information, and learning information about a previous privacy image. In addition, the second detector 124 may detect the privacy protection image s11 as an image expressed using at least one of the predetermined color and the predetermined figure of the privacy protection image s11, but an exemplary embodiment is not limited thereto.

In this instance, the release processor 126 may descramble the privacy protection image s11 detected by the second detector 124 to the privacy image s1 using a descrambling key.

The descrambling key may be identical to the scrambling key, or may be another key corresponding to the scrambling key, but an exemplary embodiment is not limited thereto.

Next, in response to a control command of the controller 140, the release processor 126 may output the first image M1 including the privacy image s1 and the general image s2, or may transfer the first image M1 to the controller 140, but an exemplary embodiment is not limited thereto.

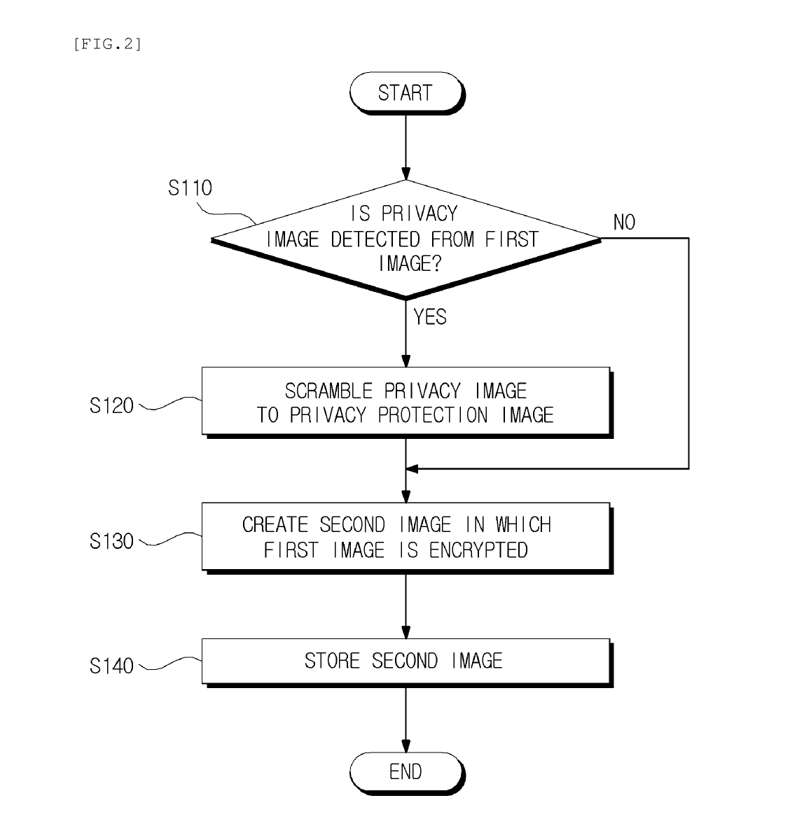

FIG. 2 is a flowchart illustrating an operation method of an image processing apparatus according to an exemplary embodiment.

Referring to FIG. 2, the image processing apparatus determines whether a privacy image s1 is detected from a first image M1 when the first image M1 is input (S110), and scrambles the privacy image s1 to a privacy protection image s11 using a scrambling key when the privacy image s1 is detected (S120).

Here, the first image M1 may include at least one of the privacy image s1 including user information, for example, at least one of facial information, license plate information, and privacy information, and a general image s2 excluding the privacy image s2.

Specifically describing, the image processing apparatus determines whether the privacy image s1 is detected from the first image M1 when the first image M1 is input.

Here, the image processing apparatus may detect the private image s1 based on at least one of edge information of the first image M1, shape information, color analysis information, and learning information about a previous privacy image.

The image processing apparatus may obtain the edge information by analyzing the first image M1, may detect a boundary between a face and a portion excluding the face using the edge information, and may determine whether the face is present within the first image M1 by comparing a result of analyzing the first image M1 and shape information about a facial shape and the like.

Also, the image processing apparatus may compare the color analysis information with unique color distribution information of the face and thus, may more accurately detect the face. Additionally, the image processing apparatus may detect a facial area using learning information about the previous privacy image, including an Adaboost learning scheme and the like, but an exemplary embodiment is not limited thereto.

Here, when the privacy image s1 is detected, the image processing apparatus may perform masking by scrambling the detected privacy image s1 to the privacy protection image s11 using a set scrambling key.

After operation S120, the image processing apparatus creates a second image M2 in which the privacy protection image s11 and the general image s2 are encrypted using an encryption key (S130), and transfers the second image M2 to the image storage 130 (S140).

After operation S110, when the privacy image s1 is not detected from the first image M1, the image processing apparatus performs operation S130 so that the first image M is encrypted in operation S120.

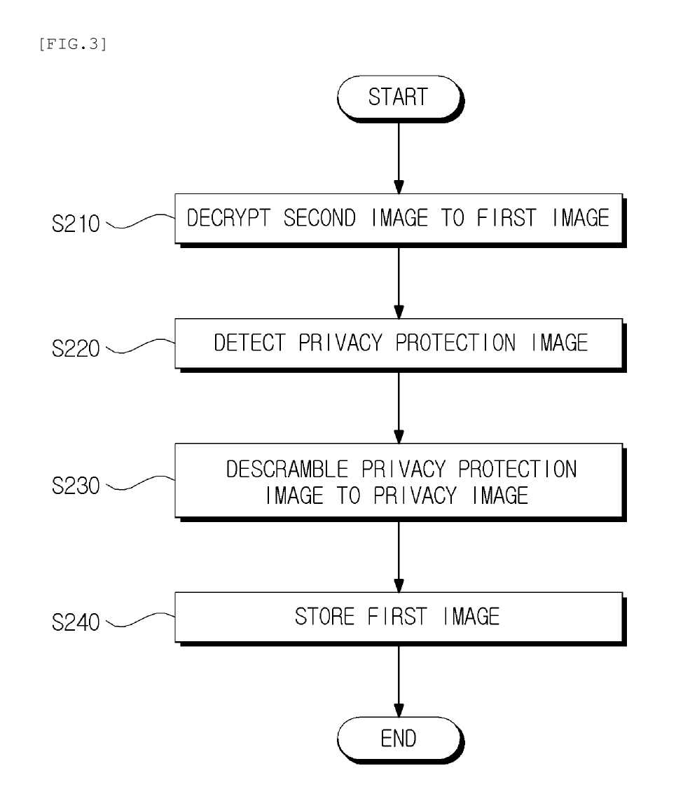

FIG. 3 is a flowchart illustrating an operation method of an image processing apparatus when an image is output from the image processing apparatus according to an exemplary embodiment.

Referring to FIG. 3, when an image request signal requesting a first image M1 is input, the image processing apparatus receives a second image M2 stored in the image storage 130, decrypts the second image M2 to a first image M1 including a privacy protection image s11 and a general image s2 using a decryption key (S210), and detects the privacy protection image s11 (S220).

Specifically describing, in response to a control command of the controller 140 and the image request signal requesting the first image M1, the image processing apparatus receives, from the image storage 130, the second image M2 to which a privacy protection algorithm corresponding to the first image M1 is applied among images stored in the image storage 130.

Next, the image processing apparatus decrypts the second image M2 to the first image M1 including the privacy protection image s11 and the general image s2 using a set decryption key.

An exemplary embodiment describes that the second image M2 includes the privacy protection image s11, but is not limited thereto.

The image processing apparatus detects, from the first image M1, the privacy protection image s11 that is expressed using at least one of a predetermined color and a predetermined figure.

After operation S220, the image processing apparatus descrambles the privacy protection image s11 to the privacy image s1 using a descrambling key (S230), and creates the first image M1 including the privacy protection image s1 and the general image s2.

Specifically describing, the image processing apparatus creates the privacy image s1 by descrambling, using the descrambling key, the privacy protection image 11 scrambled using a scrambling key.

Next, the image processing apparatus creates the first image M1 including the privacy protection image s1 and the general image s2, and transfers the first image M1 to the controller 140 or a predetermined device having input the image request signal.

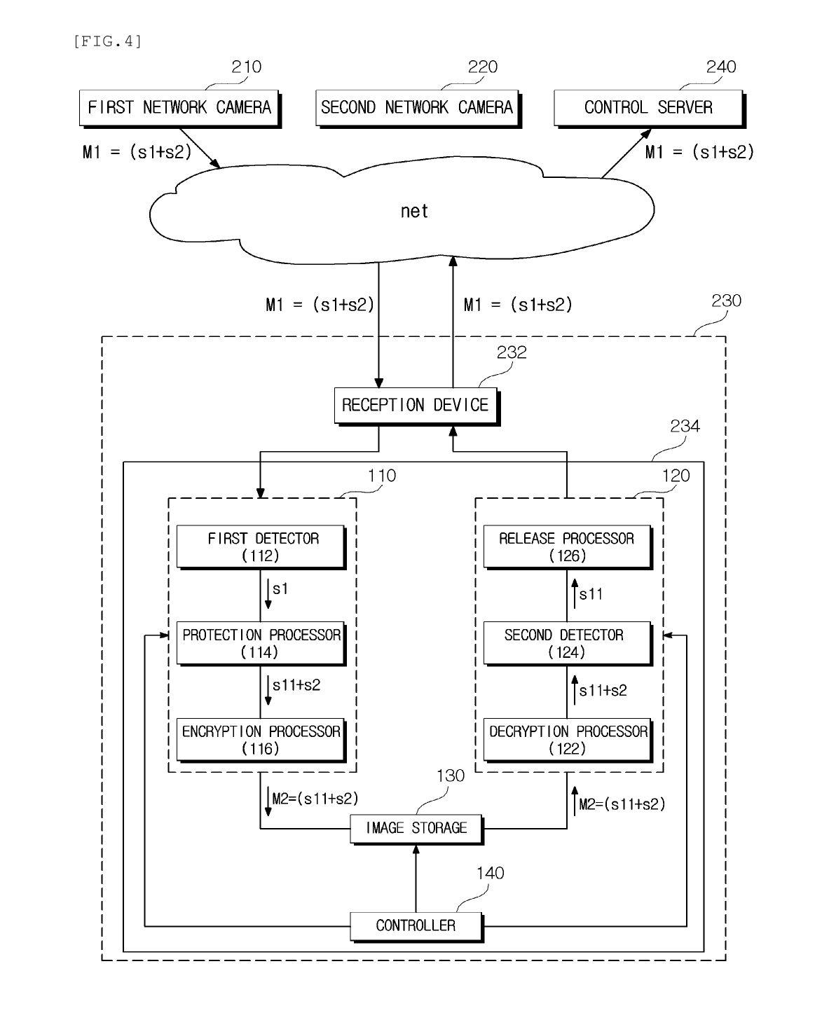

FIG. 4 is a system block diagram briefly illustrating a network camera system including the image processing apparatus of FIG. 1.

Referring to FIG. 4, the network camera system may include first and second network cameras 210 and 220, a storage server 230, and a control server 240.

Even though an exemplary embodiment describes that the number of first and second network cameras 210 and 220 is two, one network camera or at least three network cameras may be provided. An exemplary embodiment is not limited to the number of network cameras.

Also, the first and second network cameras 210 and 220 may be at least one of a mobile terminal and a CCTV terminal, and may be a device capable of photographing an image. Between the first and second network cameras 210 and 220, the first network camera 210 may transmit, to the storage server 230, a first image M1 photographed using a network (net), for example, the Internet or an Intranet.

In this instance, the storage server 230 may include a reception device 232 configured to receive the first image M1 transmitted from the first network camera 210 and an image processing apparatus 234 configured to create and store a second image M2 by applying a privacy protection algorithm to the first image M1 received by the reception device 232.

Here, when the reception device 232 receives an image request signal about the first image M1 from the control server 240, the reception device 232 is provided with the first image M1 from the image processing apparatus 234 and transmits the first image M1 to the control server 240.

The reception device 232 is a device capable of performing transmission and reception with the first and second network cameras 210 and 220 and the control server 240, and an exemplary embodiment is not limited thereto.

The image processing apparatus 234 is described to have the same configuration as the image processing apparatus of FIG. 1.

The image processing apparatus 234 may include a privacy protection processor 310 configured to create the second image M2 by applying the privacy protection algorithm to the first image M1 when the first image M1 is input, a privacy release processor 320 configured to create the first image M1 by applying a privacy release algorithm to the second image M2 in response to a request for the first image M1, an image storage 330 configured to store the second image M2 created by the privacy protection processor 310 and provide the second image M2 to the privacy release processor 320, and a controller 340 configured to control the privacy protection processor 310, the privacy release processor 320, and the image storage 330.

In an exemplary embodiment, the image storage 330 included in the image processing apparatus 234 may be a separate image storage server (not shown) different from the image processing apparatus 234 due to a characteristic of the storage server 230, but an exemplary embodiment is not limited thereto.

Also, the privacy protection processor 310, the privacy release processor 320, the image storage 330, and the controller 340 have the same operational characteristics as the privacy protection processor 110, the privacy release processor 120, the image storage 130, and the controller 140 of FIG. 1 and thus, a detailed description will be omitted.

To monitor the first image M1 photographed from the first network camera 210, the control server 240 may transmit, to the storage server 230, an image request signal requesting the first image M1, and may receive the first image M1 from the storage 230 and monitor the first image M1.

Also, when at least one of the first and second network cameras 210 and 220 requests the first image M1, the control server 240 may receive the first M1 from the storage server 230 and may transmit the first image M1 to at least one of the first and second network cameras 210 and 220.

As described above, the exemplary embodiments have been described and illustrated in the drawings and the specification. The exemplary embodiments were chosen and described in order to explain certain principles of the invention and their practical application, to thereby enable others skilled in the art to make and utilize various exemplary embodiments of the present invention, as well as various alternatives and modifications thereof. As is evident from the foregoing description, certain aspects of the present invention are not limited by the particular details of the examples illustrated herein, and it is therefore contemplated that other modifications and applications, or equivalents thereof, will occur to those skilled in the art. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. An operation method of an image processing apparatus, the method comprising:
detecting a privacy image from a first image when the first image is input;
scrambling the privacy image to a privacy protection image using a scrambling key when the privacy image is detected; and
creating a second image in which the first image including the privacy protection image is encrypted using an encryption key.

2. The method of claim 1, wherein the detecting of the privacy image detects the privacy image based on at least one of edge information of the first image, shape information, color analysis information, and learning information about a previous privacy image.

3. The method of claim 1, wherein the privacy image is an image in which at least one of facial information, license plate information, and privacy information is included.

4. The method of claim 1, wherein the scrambling expresses the privacy image using a predetermined color or a predetermined figure.

5. The method of claim 1, further comprising:
storing and managing the second image.

6. The method of claim 1, further comprising:
decrypting the second image to the first image including the privacy protection image using a decryption key;
detecting the privacy protection image; and
creating the first image in which the privacy protection image is descrambled to the privacy image using a descrambling key, when the privacy protection image is detected.

7. The method of claim 6, wherein the detecting of the privacy protection image detects the privacy protection image that is expressed using at least one of a predetermined color and a predetermined figure.

8. An image processing apparatus, comprising:
a first detector configured to detect a privacy image from a first image when the first image is input;
a protection processor configured to scramble the privacy image to a privacy protection image using a scrambling key when the privacy image is detected; and
an encryption processor configured to create a second image in which the first image including the privacy protection image is encrypted using an encryption key.

9. The apparatus of claim 8, wherein the first detector detects the privacy image based on at least one of edge information of the first image, shape information, color analysis information, and learning information about a previous privacy image.

10. The apparatus of claim 8, wherein the privacy image is an image in which at least one of facial information, license plate information, and privacy information is included.

11. The apparatus of claim 8, wherein the protection processor expresses the privacy protection image using a predetermined color or a predetermined figure.

12. The apparatus of claim 8, further comprising:
an image storage configured to store and manage the second image.

13. The apparatus of claim 8, further comprising:
a decryption processor configured to decrypt the second image to the first image including the privacy protection image using a decryption key, when the second image is input;
a second detector configured to detect the privacy protection image; and
a release processor configured to create the first image in which the privacy protection image is descrambled to the privacy image using a descrambling key, when the privacy protection image is detected.

14. The apparatus of claim 13, wherein the second detector detects the privacy protection image that is expressed using at least one of a predetermined color and a predetermined figure.
